(19) United States
(12) Patent Application Publication
(10) Pub. No.: US 2025/0176536 A1
(43) Pub. Date: Jun. 5, 2025

(54) ANTIMICROBIAL AND/OR ANTIVIRAL MATERIALS

(71) Applicant: KLURA LTD, Suffolk (GB)

(72) Inventors: Payam NAHAVANDI, Suffolk (GB); Mohammad MOHSENI, Suffolk (GB); Reza MOGHADDAM, Suffolk (GB); Masoomeh BAZZAR, Suffolk (GB); Osama ALSWAFY, Suffolk (GB); Robyn JERDAN, Suffolk (GB); Cigdem WILLIAMS, Suffolk (GB); Mohamed BAZBOUZ, Suffolk (GB); Atif AZIZ, Suffolk (GB); Rajinder SHARMA, Suffolk (GB)

(73) Assignee: KLURA LTD, Suffolk (GB)

(21) Appl. No.: 18/849,038

(22) PCT Filed: Mar. 28, 2023
(86) PCT No.: PCT/GB2023/050796

§ 371 Date: Sep. 20, 2024

(30) Foreign Application Priority Data
Mar. 28, 2022 (GB) 2204394.7

(51) Int. Cl. A01N 25/10; A01P 1/00; C08C 1/14; C08L 9/04

(52) U.S. Cl. CPC A01N 25/10; A01P 1/00; C08C 1/14; C08L 9/04

(57) ABSTRACT

Described a coagulant formulation for use in the preparation of a material that is formed by dipping, wherein the formulation includes one or more non-biological antimicrobial and/or antiviral agent.

The present invention relates to formable materials that have antimicrobial, antibacterial and/or antiviral properties. In particular, these properties are intrinsic to the material by virtue of the fabrication process. The invention has particular application to the manufacture of synthetic and non-synthetic elastic and inelastic polymer products.

An example of an elastic polymer product is disposable gloves. Disposable gloves are an essential item in many environments, particularly healthcare, where they protect workers and customers/patients from exposure to potentially dangerous microbes and provide essential hygiene. Elastic and inelastic polymer products, including disposable gloves, are generally made from one of three materials: nitrile, latex, or vinyl, as well as a blend of nitrile and vinyl.

For decades, latex has been the material of choice, particularly in the medical disposable glove world. This is because latex gloves were recommended protection in the 1980s and 1990s against bloodborne pathogens like HIV. But, as their popularity increased, so did cases of allergic reactions. This led to more demand for latex-free disposable glove alternatives, like nitrile and vinyl. For those who are not allergic, latex gloves are comfortable, relatively cost-effective, and offer a high degree of touch sensitivity.

Vinyl gloves are made from polyvinyl chloride (PVC), a petroleum-based film and a monomeric material. A plasticiser is sometimes added to make the material suitably flexible for glove use. The primary benefit of vinyl disposable gloves is that they are inexpensive to manufacture. However, they are less durable than latex and nitrile, and they offer limited protection against chemical or biomedical exposure. When vinyl gloves are stretched or flexed, the individual molecules separate, and the integrity of the protective barrier is compromised. Vinyl gloves are also a concern in terms of their environmental impact. Due to their low cost and low protection levels, vinyl gloves are commonly used in non-hazardous and low-infection environments.

Nitrile gloves came to prominence in the 1990s as a leading alternative to latex. While they are not as elastic or flexible as their latex counterparts, disposable nitrile gloves are notably more durable and resistant to chemicals. As such, these gloves are the ideal choice for anyone who has to handle potentially hazardous and corrosive chemicals. They are also perfectly suited for most medical environments, being exceptionally puncture-resistant and eliminating the risk of latex allergy reactions.

Nitrile, sometimes called nitrile butadiene rubber (NBR), is a copolymer of butadiene and acrylonitrile. This is important for nitrile because it derives several key benefits from both butadiene and acrylonitrile. Acrylonitrile is a volatile synthetic liquid with a strong smell and butadiene is a colourless gas and organic compound that can easily become liquid.

Acrylonitrile (C₃H₃N) is made through the SOHIO process which reacts propane, ammonia, water, and air to synthesise both acrylonitrile and acetonitrile. Acetonitrile is used in the synthesis of butadiene. Butadiene (C₄H₆) is made as a by-product in the production of ethylene, which happens through steam cracking. Butadiene is then obtained through extractive distillation: this process filters through heavier by-products in order to extract butadiene. Nitrile is then formed through the co-polymerisation of both acrylonitrile and butadiene, in which they are reacted together and ultimately formed into crude, synthetic rubber. The nitrile is then moulded into gloves.

Butadiene provides nitrile with flexibility and puncture/tear resistance (three times as puncture resistant as latex), while acrylonitrile enhances the chemical resistance. These unique chemical qualities are what give each material its benefits as a glove. Latex, for example, is the most flexible of the three, while nitrile is the most durable, and vinyl is the least expensive.

Thanks to butadiene and acrylonitrile, nitrile gloves have a few unique benefits that are not found in other gloves. First and foremost is nitrile's tensile strength. Nitrile is one of the most durable glove materials currently on the market, offering three times the durability of latex. In addition, nitrile offers impressive heat resistance, with a functional temperature range between-4° C. and 110° C. This makes nitrile an excellent choice for the handling of hot and cold materials for extended periods of time.

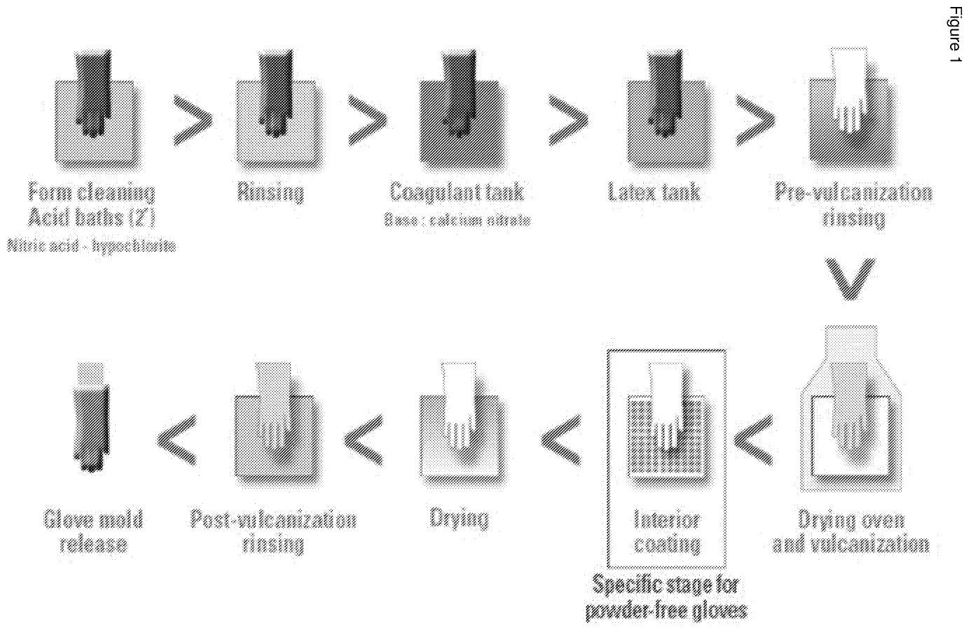

Because nitrile and vinyl gloves are made from synthetic materials, they are manufactured slightly differently to latex gloves. The manufacturing process described below and illustrated in FIG. 1 mainly focuses on nitrile gloves, but the concept is applicable equally to all four types of glove material.

First, the manufacturing equipment runs ceramic or aluminium hand-shaped formers through water and bleach to clean them and remove residue from previous manufacturing runs. The formers are then dried before being dipped in a mixture of calcium carbonate and calcium nitrate, which helps the synthetic materials coagulate around the formers. The formers are then dried again.

Next, the formers are dipped in tanks of NBR or PVC, depending on the type of glove being made. The gloves are then heated at a high temperature (vulcanisation) to form the gloves as they dry.

To help nitrile gloves go on more easily, they undergo one of two processes: polymer coating or chlorination. Polymer coating involves adding a layer of polymer to lubricate the glove's surface, whereas chlorination exposes the glove to a chlorine acid or gas mixture to make the material harder and more slick.

The last phase of the production process is called the stripping phase, in which blasts of air remove the gloves from the formers.

It may be argued that the coagulant formulation has the most important role in the manufacturing of gloves. For example, Ansell Ltd has patented over ten formulations just for the coagulant alone. The formulation of the coagulant varies depending on the type of glove being made and the processing setting of the manufacturing line. Below are two examples of the coagulant formulation used by Ansell Ltd:

| | | | |
|---|---|---|---|
| Anhydrous calcium chloride | 15 pbw (parts by weight) | calcium nitrate tetrahydrate | 60 pbw |
| Calcium nitrate tetrahydrate | 15 pbw | distilled water | 30 pbw |
| Methy/ethyl alcohol | 50 pbw | acetone | 5 pbw |
| Water | 20 pbm | non-ionic wetting agent | 1 pbw |

As can be seen from the above, calcium nitrate exists in both formulations and, in fact, is the most important ingredient in the coagulation process and the common element in most coagulant formulations. Calcium nitrate aids the pick-up of the raw material (e.g. nitrile) at the next stage and acts as the binder of the nitrile polymer. In fact, it is the concentration of the calcium nitrate in the coagulant which determines the final thickness of the glove.

Generally, the coagulant formulation consists of calcium nitrate, an anti-tack (demoulding) ingredient such as calcium stearate which aids the removal of the glove from the former, wetting agents and solvents.

In light of recent world health matters, it has become important to impart antimicrobial and/or antiviral properties to substrates and surfaces. For the avoidance of doubt, the term “antimicrobial” refers to an effect against a wide spectrum of microbes including bacteria, mould, fungi and viruses.

Coatings have been explored for disposable materials and one such product is provided by Biocote® Ltd. The antimicrobial/antibacterial additives used are Silver Ion, Copper, Zinc and organic additives including phenolic biocides, quaternary ammonium compounds and fungicides (e.g. thiabendazole) which are included in the coagulation tank. Specifically, this glove material utilises ZnO and TiO₂ in its coagulant formulation. However, the antimicrobial/antiviral efficacy of these coatings is low, and it takes hours for any antimicrobial action to take effect.

One particular concern for materials with antimicrobial/antiviral properties is access to the antimicrobial/antiviral effect of any active agent. Therefore, while a material may include one or more active agent that imparts antimicrobial/antiviral to that material, for example by adding one or more antimicrobial/antiviral agents to a dipping solution, such a property is likely to be reduced or limited because the agent(s) is/are deposited on the inside of the formed material which offers little protection against pathogens touching the external surfaces of the formed material. Therefore, a coating is the most desirable option.

However, coating formed materials, particularly disposable gloves, is not straight forward. As explained above, gloves are manufactured on formers and so coating must take place either by coating formers before glove material is deposited, or after gloves have been cured and removed from the formers. This is because gloves are formed inside-out. While formers may be sprayed, dipped, or coated prior to dipping in a coagulation tank, this adds one or more manufacturing steps and associated cost so is less desirable.

Another consideration with coatings is that they, naturally, impart a surface layer. Such a layer can impact on physical properties of the material, including flexibility, stickiness, touch sensitivity, and is at risk of cracking, washing and/or rubbing off in use.

It is in this context that the present invention has been devised. In view of the drawbacks of added coatings, the present invention provides a coagulant formulation for use in the manufacture of formed materials, in which the coagulant formulation imparts antimicrobial and/or antiviral properties to an external surface of the formed material.

Accordingly, in a first aspect, the present invention resides in a coagulant formulation for use in the manufacture of a material formed by dipping, the coagulant formulation comprising a coagulant, one or more wetting agent surfactant and solvent, wherein the formulation further comprises one or more non-biological antimicrobial and/or antiviral agent. For the avoidance of doubt, the term “antimicrobial” encompasses bacteria and fungi. In addition, the term “non-biological” is used in this context with its standard meaning being not involving or derived from biology or living organisms and not relating to, marked by, or derived from life and living processes.

The coagulant formulation is particularly suitable for the forming of latex, nitrile, vinyl and/or nitrile/vinyl, especially in the dipping process as described herein above.

In one embodiment, the one or more non-biological antimicrobial and/or antiviral agent is selected from: a disinfectant, a cleaning and/or sanitising, agent a bleach, an alcohol, an oxidant, a weak acid, or a bactericidal agent and combinations thereof. For example, the one or more non-biological antimicrobial and/or antiviral agent may be electrolysed water, hypochlorous acid, sodium dichloroisocyanurate (NaDCC), a metal oxide, a poloxamer, a quaternary ammonium salt, fluoride ions, chitosan, poly(hexamethylene guanidine) (PHMG), carnosol, alpha-tocopherol, glutaraldehyde (GA), hyaluronic acid, citric acid, acetic acid, an alcohol, chlorhexidine digluconate, powdered alcohol, and combinations thereof. In a specific example, the one or more non-biological antimicrobial and/or antiviral agent is hypochlorous acid (HOCl), electrolysed water or precursors thereof such as NaDCC.

Ideally, the one or more non-biological antimicrobial and/or antiviral agent may be present in the formulation in an amount of between about 0.1% and about 20%. For example, where the one or more non-biological antimicrobial and/or antiviral agent is HOCl, a concentration of between about 0.1% and about 10% is appropriate.

In an embodiment, the formulation may further include one or more encapsulation agent. Such an agent helps slow the release of the active (antimicrobial/antiviral) agent (such as HOCl) which, in turn, assists with the stability and lifetime of the antimicrobial/antiviral activity of the active agent in/on the material. Such agents also help with the uniform integration of active agent within the matrix of the material polymers such that there is no damage to the structure and integrity of the formable material.

Examples of suitable encapsulation agents include ethyl cellulose (EC), methyl cellulose and sodium carboxy methyl cellulose, Poly(ethylene glycol) (PEG), polyethylene oxide (PEO), Polyvinyl pyrrolidone (PVP), Polyvinyl alcohol (PVA), Polyacrylic acid (PAA), Polyacrylamides, N-(2-Hydroxypropyl) methacrylamide (HPMA), poly Divinyl Ether-Maleic Anhydride, Polyoxazolines, Polyphosphates, Polyphosphazenes, Xanthan Gum, Pectin, Chitosan, Dextran, Carrageenan, Guar Gum, Hydroxypropylmethyl cellulose (HPMC), Hydroxypropyl cellulose (HPC), Hydroxyethyl cellulose (HEC), Sodium carboxy methyl cellulose (Na-CMC), Hyaluronic acid (HA), Albumin, Starch, gum arabic, dextrin glue, glycerol, and combinations thereof. It will be appreciated that these are water-soluble polymers.

Examples of suitable water insoluble or solvent-based polymers include cellulose including ethyl cellulose, methyl cellulose, cellulose acetate and cellulose acetate butyrate, poly(methyl methacrylate) (PMMA), poly(2-phenyl-2-oxazoline) (PPhOx), polyethylene oxide (PEO), poly(2-hydroxyethyl methacrylate), poly(1,2butylene glycol) (PBG), polyacrylonitrile, polyvinyl chloride, polyvinylidene fluoride, and combinations thereof.

Combinations of water-soluble and water insoluble or solvent-based polymers are also encompassed in the scope of the present invention.

Where the one or more encapsulation agent is Sodium carboxy methyl cellulose and/or methyl cellulose, both or either of which may be present in the formulation at a concentration of between about 0.1% and about 5%. Where the one or more encapsulation agent is ethyl cellulose, a concentration of between about 0.1% and about 5% is suitable.

In an embodiment, the formulation may further include one or more plasticiser. Alternatively, the one or more non-biological antimicrobial and/or antiviral agent may be selected also for its plasticiser properties. It will be appreciated that a plasticiser is a substance added to a formulation to produce or promote plasticity and flexibility and to reduce brittleness. Suitable plasticisers include glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, soybean oil, dodecanol, lauric acid, tributyrin, trilaurin, epoxidised soybean oil, mannitol, diethanolamine, fatty acids, triethyl citrate, and/or sucrose esters, and combinations thereof. A plasticiser concentration in the formulation of between about 0.1% and about 5% is suitable.

It will be appreciated that suitable amounts of coagulant are known to the skilled person and easily derivable from the art, as the coagulant influences the thickness of the material produced. However, for the particular application of this invention, the coagulant may be present in the formulation in an amount of between about 2% and about 20%, optionally about 14%. Examples of coagulants include calcium nitrate, calcium chloride, ammonium nitrate.

Suitable wetting agent surfactants are known to the skilled person and may be selected according to preference and final utility of the material, in accordance with standard skill and knowledge. Two common wetting agents used in coagulants are Teric® 320 and Surfynol® TG.

It will be appreciated that water typically makes up the balance of the coagulant formulation of the invention. However, other constituents may also be present, such as alcohol and/or acetone.

In an embodiment, the formulation may further include one or more anti-tack agent, such as calcium stearate, zinc stearate and magnesium stearate. As an example, the one or more anti-tack agent may be present in the formulation in an amount of between about 0.1% and about 5%, optionally about 1.8%.

In a further embodiment, the formulation may further include a neutral, pleasant, or unpleasant fragrance and/or flavouring, and/or colourant.

In a second aspect, the present invention encompasses a method for producing a formable material in which the method comprising the steps of:
a) dipping a former in a coagulant formulation to produce a coagulant-dipped former,
b) drying the dipped former to produce a dried coagulant-dipped former,
c) dipping the dried former in a solution comprising latex, nitrile, polyvinyl chloride and/or a mixture of nitrile/PVC to produce a coated former, and
d) curing the coated former,
   wherein the coagulant formulation is a coagulant formulation as defined and described herein.

Coagulant dipping is the first step in the manufacture of latex, nitrile, vinyl and/or nitrile/vinyl (“rubber”) materials, meaning that the coagulation layer will be then exposing the outside layer of the material once cured and removed from formers.

In a particular embodiment, the former may be dipped in coagulant formulation for between about 10 seconds and up to about 3 minutes. Suitable time periods may be 1 second, 30 seconds, about 1 minute or about 3 minutes. This time period is termed the “dwell” time and it influences the thickness of the material. A suitable temperature for dipping may be between about 18° C. and about 50° C., preferably at about 25° C. A temperature of about 45° C. has also been found to be suitable.

In a particular embodiment, the coagulant-dipped former from step a) may be dried for between about 10 seconds and about 5 minutes. Suitable time periods may be a 1 second, 30 seconds, about 1 minute or about 5 minutes. A suitable temperature for dipping may be between about 60° C. and about 90° C. Temperatures of about 60° C., between about 60° C. and about 75° C., and about 90° C. have been found to be suitable.

In a particular embodiment, the dried coagulant-dipped former from step b) may be dipped in the latex, nitrile, polyvinyl chloride and/or nitrile/PVC mixture solution for between about 10 seconds and about 5 minutes. Suitable time periods may be a 1 second, 30 seconds, about 2 minutes or between about 3 minutes and about 5 minutes. A suitable temperature for dipping may be between about 18° C. to about 35° C. A temperature of about 25° C., or between about 25° C. and about 35° C., have been found to be suitable.

In a particular embodiment, the coated former from step c) may be cured for between about 6 minutes and about 20 minutes. Suitable time periods may be about 6 minutes, about 15 minutes or about 20. A suitable temperature for curing may be between about 90° C. and about 130° C. Temperatures of about 90° C., between about 100° C. to about 125° C., or about 130° C. have been found to be suitable.

In a yet further embodiment, the method may further include a pre-step in which the former is heated before being dipped in coagulant formulation. In a particular example, the former may be heated for about 2-3 minutes. A suitable temperature has been found to be in a range of between about 50° C. and about 60° C.

In an embodiment, the formable material and former are for the manufacture of synthetic and non-synthetic elastic and inelastic polymer products, such as but not limited to condoms, finger cots, catheters, cannulas, baby soothers, elastic clothing, and surface coverings. In a particular embodiment, the formable material and former are for the manufacture of a glove, optionally a disposable glove.

The present invention will now be described in more detail with reference to the following figures, in which:

FIG. 1: a schematic diagram illustrating the manufacturing steps for the fabrication of nitrile gloves published by Ansell Ltd.

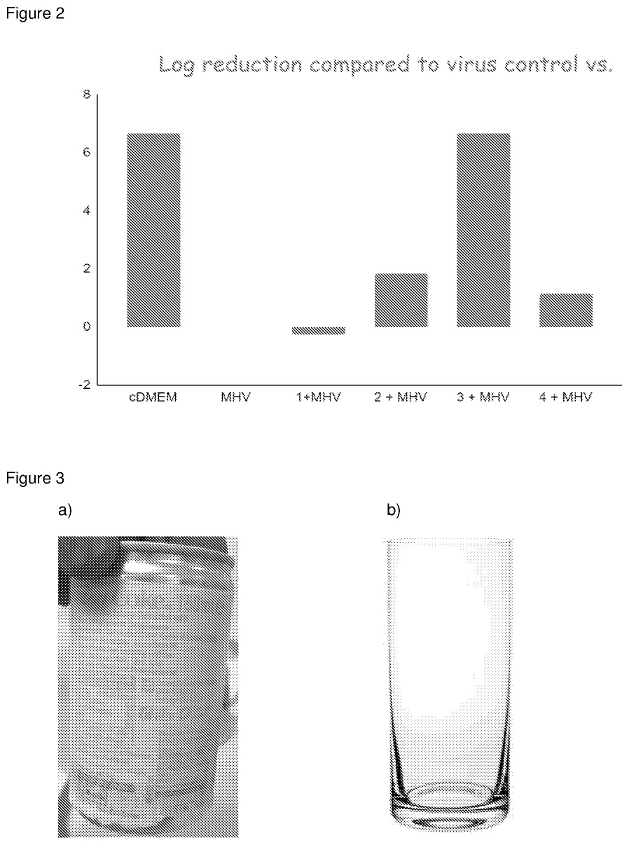

FIG. 2: Antiviral effect of a coagulant formulation including ethyl cellulose. Positive control=CDMEM (Dulbecco's Modified Eagle Medium); negative control=Mouse hepatitis virus (MHV) alone; 1+MHV=test control; commercial coagulant formulation and nitrile solutions; 2+MHV=coagulant formulation including final concentrations of 1% ethyl cellulose, 10,000 ppm HOCl, 3.5% calcium nitrate, 0.45% calcium stearate and about 0.2% wetting agent surfactants; 3+MHV=coagulant formulation including final concentrations of 5% ethyl cellulose and 10,000 ppm HOCl, 3.5% calcium nitrate, 0.45% calcium stearate and about 0.2% wetting agent surfactants; 4+MHV=coagulant formulation including final concentrations of 20,000 ppm HOCl, 14% calcium nitrate, 1.8% calcium stearate and about 0.5% wetting agent surfactants.

FIG. 3: formers used for nitrile film fabrication. FIG. 3a: an aluminium can, FIG. 3b: a cylindrical-shaped glass, FIG. 3c: a ceramic manikin hand.

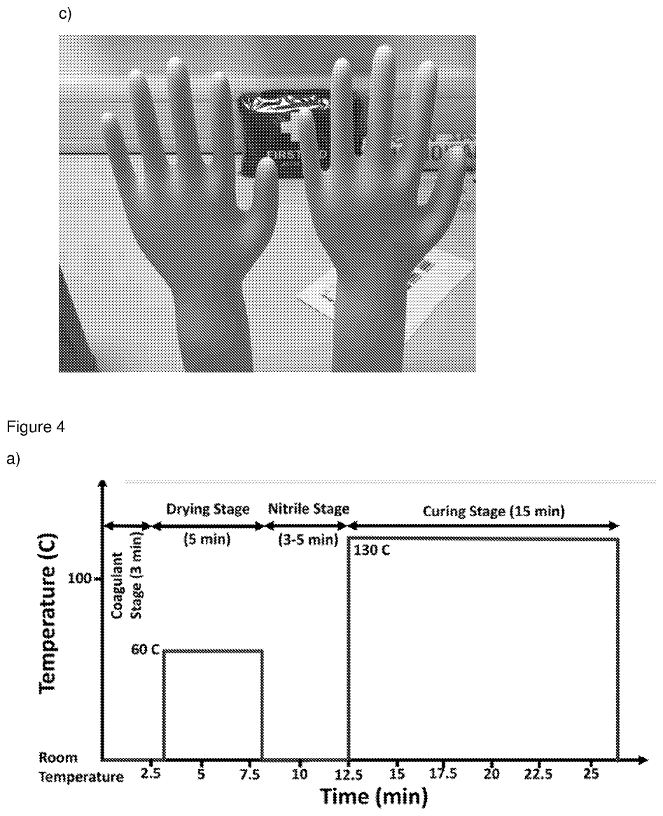

FIG. 4: schematic diagrams illustrating three dipping processes. FIG. 4a: Protocol M,

FIG. 4b: Protocol B, FIG. 4c: Protocol C.

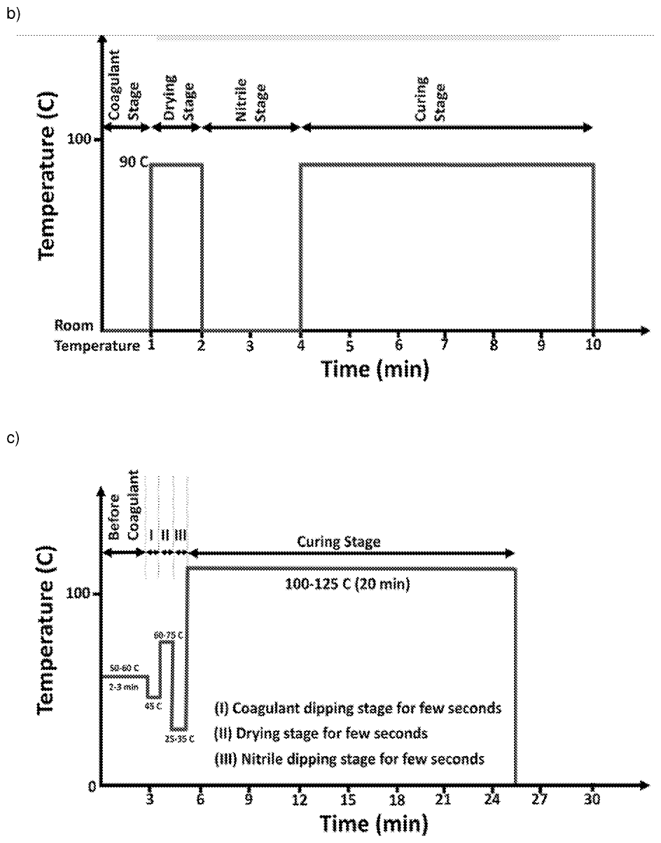

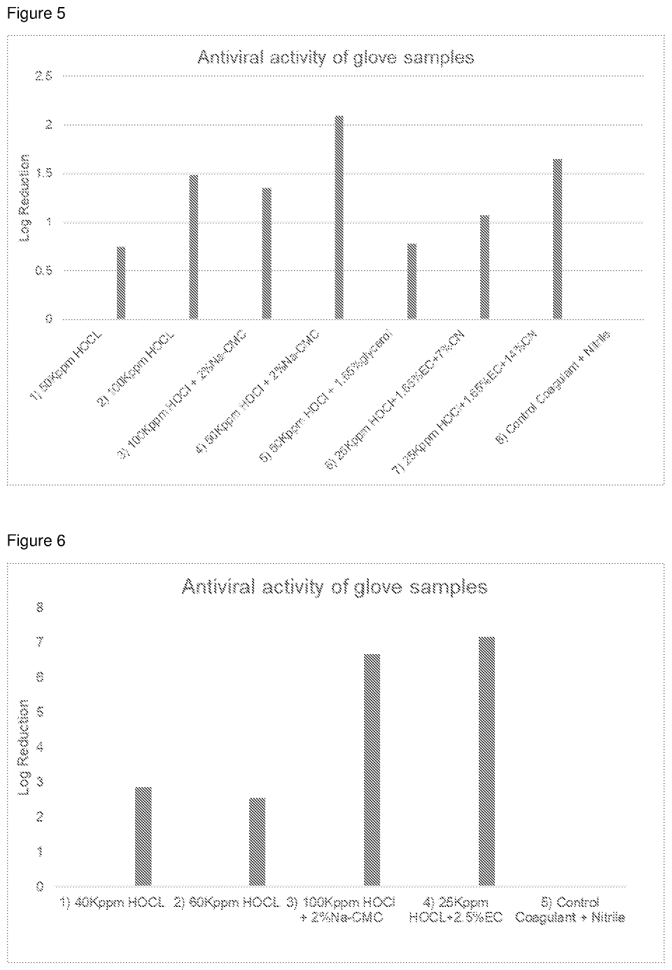

FIG. 5: graph comparing antiviral effect of nitrile gloves prepared using Protocol M and different coagulant formulations.

FIG. 6: graph comparing antiviral effect of nitrile gloves prepared using Protocol B and different coagulant formulations.

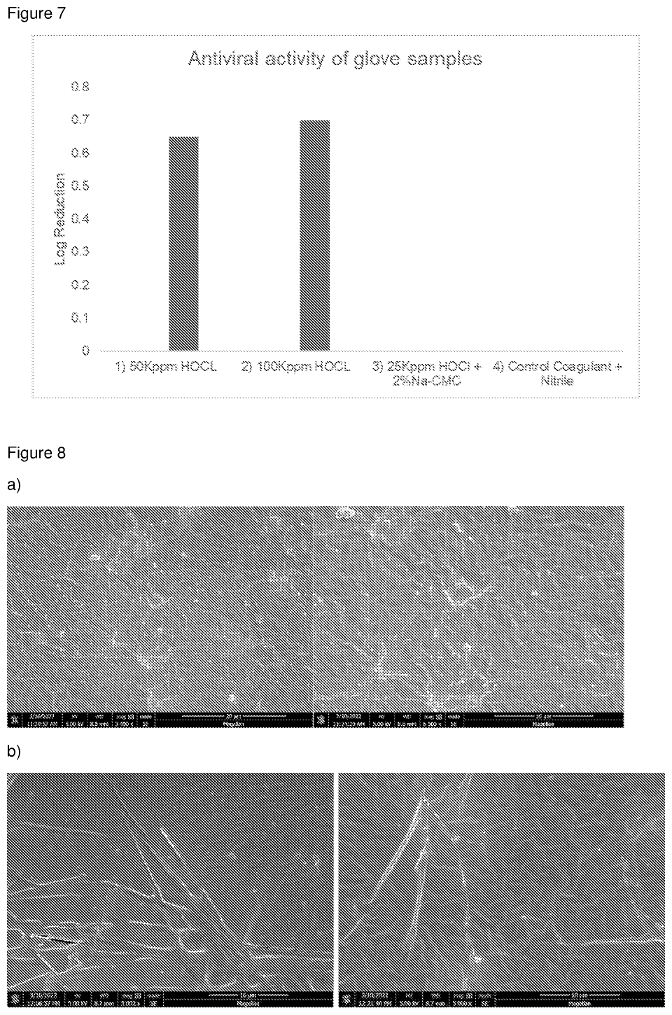

FIG. 7: graph comparing antiviral effect of nitrile gloves prepared using Protocol C and different coagulant formulations.

FIG. 8: scanning electron micrograph images of material samples prepared using different coagulant formulations. FIG. 8a-nitrile material formulated with commercially available coagulant and nitrile; FIG. 8b-nitrile material prepared with a coagulant formulation including 50,000 ppm HOCl, 14% calcium nitrate, 1.8% calcium stearate and about 0.5% wetting agent surfactants; FIG. 8c-nitrile material prepared with a coagulant formulation including 5% HOCl, 1.5% Na-CMC, 14% CaNO₃, FIG. 8d-nitrile material prepared with a coagulant formulation including 50 Kppm HOCl+2% Na-CMC, 14% calcium nitrate, 1.8% calcium stearate and about 0.5% wetting agent surfactants; FIG. 8e-nitrile material prepared with a coagulant formulation including 50 Kppm HOCl+1.65% glycerol, 14% calcium nitrate, 1.8% calcium stearate and about 0.5% wetting agent surfactants.

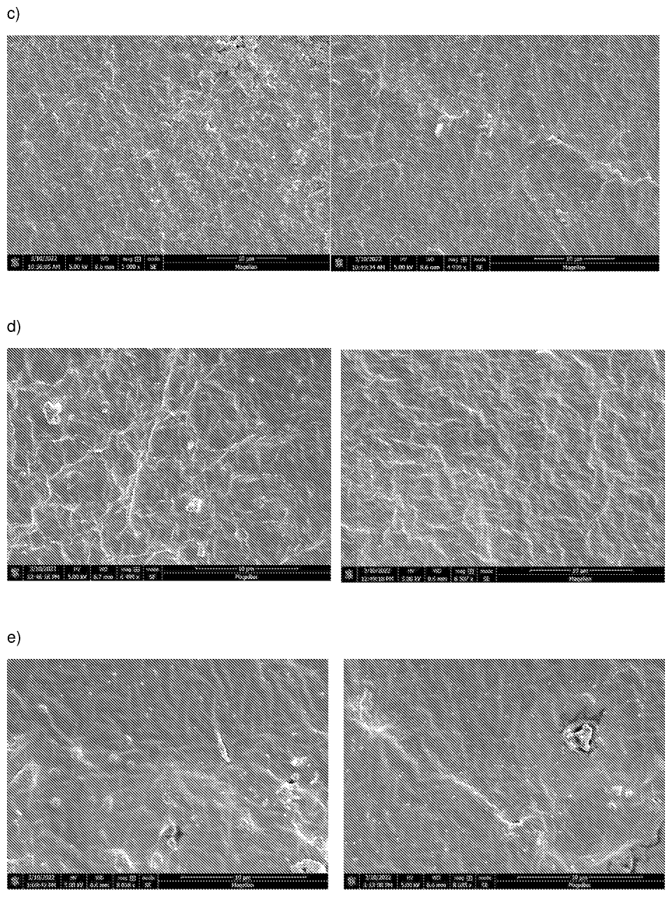

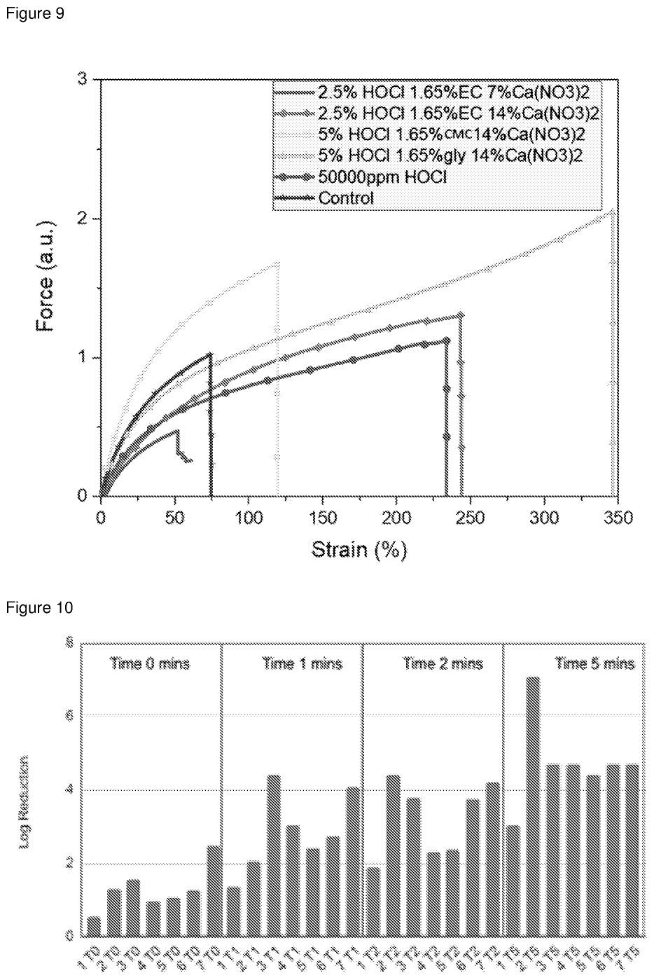

FIG. 9: graph showing the tensile strength performance of the nitrile materials containing the differing coagulant formulations with respect to a control material (i.e. units in arbitrary units).

FIG. 10: graph comparing the antibacterial effect of nitrile material incorporating different coagulant formulations prepared using the Protocol M method against Staphylococcus aureus measured at time-points of 0 min (T0), 1 min (T1), 2 mins (T2) and 5 mins (T5) contact time. 1) Control=control coagulant (14% calcium nitrate, 1.8% calcium stearate and about 0.5% wetting agent surfactants)+nitrile; 2) 5% HOCl+1.65% glycerol+14% calcium nitrate, 1.8% calcium stearate and about 0.5% wetting agent surfactants; 3) 10% HOCl+14% calcium nitrate, 1.8% calcium stearate and about 0.5% wetting agent surfactants; 4) 2.5% HOCl+1.65% EC+7% calcium nitrate, 0.45% calcium stearate, 0.2% wetting agent surfactants; 5) 2.5% HOCl+1.65% EC+14% calcium nitrate, 1.8% calcium stearate and about 0.5% wetting agent surfactants; 6) 5% HOCl+14% calcium nitrate, 1.8% calcium stearate and about 0.5% wetting agent surfactants; 7) 5% HOCl+1.65% NA-CMC+14% calcium nitrate, 1.8% calcium stearate and about 0.5% wetting agent surfactants.

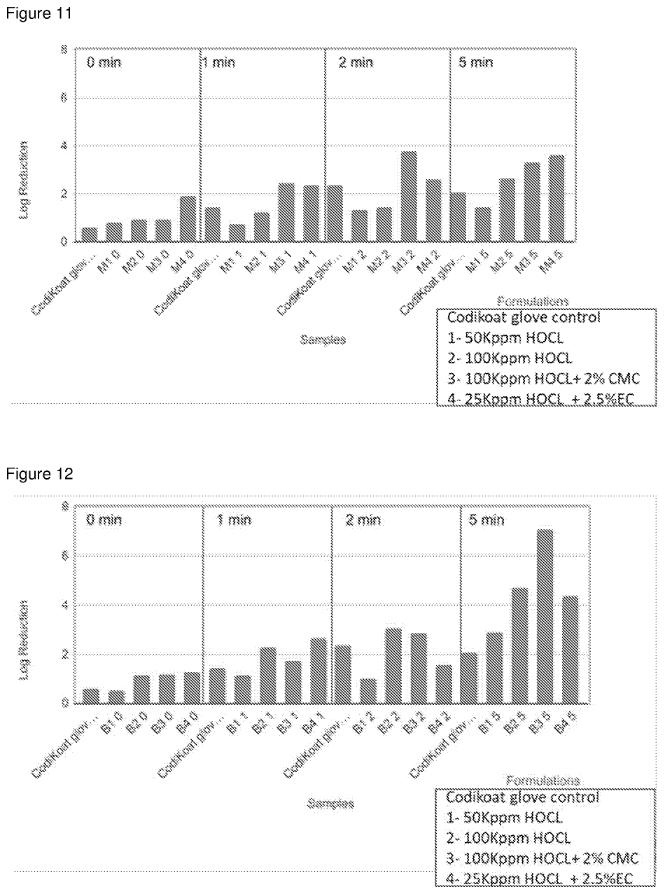

FIG. 11: graph comparing the antibacterial effect of nitrile material incorporating different coagulant formulations prepared using the Protocol M method against Staphylococcus aureus measured at time-points of 0 min (TO), 1 min (T1), 2 mins (T2) and 5 mins (T5) contact time. Control=control coagulant (14% calcium nitrate, 1.8% calcium stearate and about 0.5% wetting agent surfactants)+nitrile; 1) 5% HOCl+14% calcium nitrate, 1.8% calcium stearate and about 0.5% wetting agent surfactants; 2) 10% HOCl+14% calcium nitrate, 1.8% calcium stearate and about 0.5% wetting agent surfactants; 3) 10% HOCl+2% NA-CMC+14% calcium nitrate, 1.8% calcium stearate and about 0.5% wetting agent surfactants; 4) 2.5% HOCl+2.5% EC+14% calcium nitrate, 1.8% calcium stearate and about 0.5% wetting agent surfactants.

FIG. 12: graph comparing the antibacterial effect of nitrile material incorporating different coagulant formulations prepared using the Protocol B method against Staphylococcus aureus measured at time-points of 0 min (TO), 1 min (T1), 2 mins (T2) and 5 mins (T5) contact time. Control=control coagulant (14% calcium nitrate, 1.8% calcium stearate and about 0.5% wetting agent surfactants)+nitrile; 1) 5% HOCl+14% calcium nitrate, 1.8% calcium stearate and about 0.5% wetting agent surfactants; 2) 10% HOCl+14% calcium nitrate, 1.8% calcium stearate and about 0.5% wetting agent surfactants; 3) 10% HOCl+2% NA-CMC+14% calcium nitrate, 1.8% calcium stearate and about 0.5% wetting agent surfactants; 4) 2.5% HOCl+2.5% EC+14% calcium nitrate, 1.8% calcium stearate and about 0.5% wetting agent surfactants.

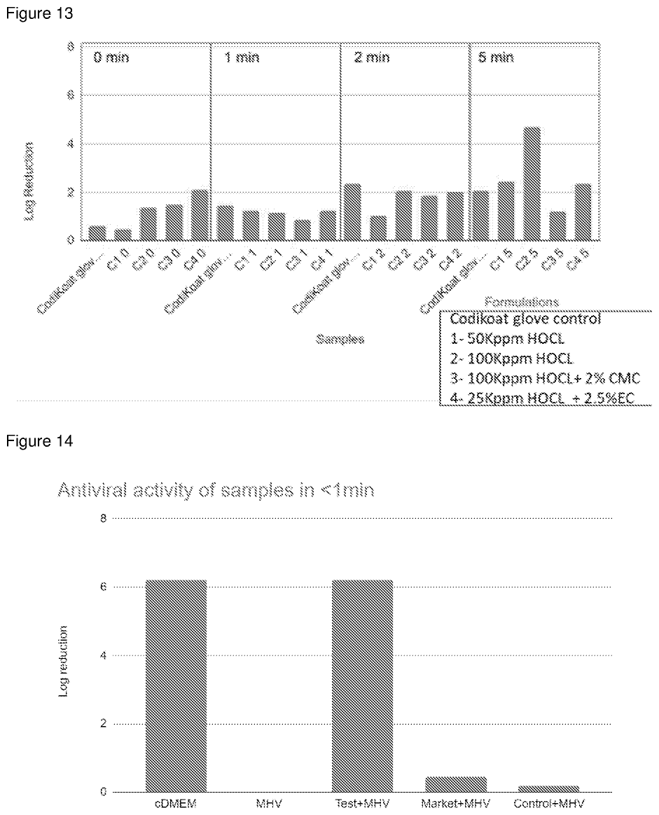

FIG. 13: graph illustrating antibacterial effect of nitrile material incorporating different coagulant formulations prepared using the Protocol C method against Staphylococcus aureus measured at time-points of 0 min (TO), 1 min (T1), 2 mins (T2) and 5 mins (T5) contact time. Control=control coagulant (14% calcium nitrate, 1.8% calcium stearate and about 0.5% wetting agent surfactants)+nitrile; 1) 5% HOCl+14% calcium nitrate, 1.8% calcium stearate and about 0.5% wetting agent surfactants; 2) 10% HOCl+14% calcium nitrate, 1.8% calcium stearate and about 0.5% wetting agent surfactants; 3) 10% HOCl+2% NA-CMC+14% calcium nitrate, 1.8% calcium stearate and about 0.5% wetting agent surfactants; 4) 2.5% HOCl+2.5% EC+14% calcium nitrate, 1.8% calcium stearate and about 0.5% wetting agent surfactants.

FIG. 14: graph comparing the antiviral properties of a nitrile material spray-coated with a coating formulation of 10,000 PPM HOCl, 1% EC and 0.1% glycerol (Test), a Biocote® glove (Market), a commercial standard control (Control).

### EXAMPLES

A number of formulations were designed for making antimicrobial coagulant solutions. Ingredients of a commercial coagulant solution used unless specified otherwise were:

| | |
|---|---|
| Calcium nitrate | 14% |
| Calcium stearate | 1.8% |
| Wetting agent surfactant: | 0.1-0.5% |
| Water | Rest (>83.7%) |

Pigmented and Unpigmented nitrile solutions had the following composition: 45% acrylonitrile-butadiene methacrylic acid copolymer and 55% water.

A cell viability assay to test antiviral activity is described below:

Formulations were tested for their effectiveness in inactivating murine hepatitis virus (MHV) in 1 minute of contact time using L929 cells. L929 cells were used at 5×10⁵ cells/ml concentration in 100 μl volume in a 96 wells format.

Neat virus stock was used (MOI of 10 for 10000 cells). 20 μl of MHV was placed on each sample and incubated for 1 minute at room temperature (25° C.).

Serial dilutions of the treated virus were carried out as follows. 20 μl of treated virus was added to the 2nd row from the bottom of the 96-well plate and mixed well. 20 μl of this mixture was added to the next above row. The process of mixing and transferring to the next row was repeated for eight concentrations whilst changing pipette tips each time. 20 μl of serially diluted MHV or control from the plates were directly transferred onto cells (‘test plate’) in quadruplicate and mixed by pipetting gently. Cells were then incubated for 48 hours. Cell infection phenotype as cell death and cytopathic effect (CPE) was observed under a benchtop light microscope (20× magnification) at 48 hours post infection (hpi) intervals.

### Example 1: Replicating Production of Gloves in the Lab at Small Scale

Nitrile material to mimic that of disposable nitrile gloves was prepared in petri dishes. 1 ml of coagulant formulation was poured into a petri dish (6 cm diameter), followed by drying on a heating plate (1-2 min and 50° C.). Then, 4 ml of nitrile was poured quickly over the coagulant layer whilst agitating the Petri dish to spread the volume of poured nitrile quickly over the whole coagulant film followed by drying on a heating plate (5-10 min and 110° C.). This process cross-links the coagulant and nitrile which becomes coagulated.

### Example 2: Antiviral Effect of Ethyl Cellulose in Coagulant

Nitrile material samples were prepared as set out in Example 1. The following formulations were prepared, and their antiviral effect tested in the cell viability assay:
1. Control material: commercial coagulant formulation and nitrile solutions set out above.
2. Material containing 1.33% ethyl cellulose and 40,000 ppm HOCl: a coagulant formulation containing 40,000 ppm HOCl was obtained by dissolving four Sanitab™ tablets (sodium dichloroisocyanurate (NaDCC)) in 100 ml of coagulant at room temperature (25° C.). Separately, a 1.33% ethyl cellulose (EC) solution was prepared in ethanol (1.33 g in 100 ml ethanol). A coagulant formulation was prepared containing 1% EC and 10,000 ppm HOCl by mixing the 1.33% stock ethyl cellulose (EC) solution dissolved in ethanol and the coagulant containing 40,000 ppm HOCl at a ratio of (75%:25%) respectively. The formulation also included 3.5% calcium nitrate, 0.45% calcium stearate and about 0.2% wetting agent surfactants.
3. Material containing 5% ethyl cellulose and 10,000 ppm HOCl: a coagulant formulation containing 40,000 ppm HOCl was obtained by dissolving four Sanitab™ tablets in 100 ml of coagulant at room temperature (25° C.). Separately, a 6.7% ethyl cellulose (EC) solution was prepared in ethanol (6.7 g in 100 ml ethanol). A coagulant formulation was prepared containing 5% EC and 10,000 ppm HOCl by mixing the 6.7% stock ethyl cellulose (EC) solution dissolved in the ethanol and the coagulant containing 40,000 ppm HOCl at a ratio of (75%:25%) respectively. The formulation also included 3.5% calcium nitrate, 0.45% calcium stearate and about 0.2% wetting agent surfactants.
4. Material containing 20,000 ppm HOCl: a coagulant formulation containing 10,000 ppm HOCl was obtained by dissolving one Sanitab™ tablet in 100 ml of coagulant. Separately, a nitrile formulation containing 10,000 ppm HOCl was obtained by dissolving one Sanitab™ tablet in 100 ml of nitrile. The formulation also included 14% calcium nitrate, 1.8% calcium stearate and about 0.5% wetting agent surfactants.

As can be seen from FIG. 2, the coagulant formulation containing 5% EC and 10 kppm HOCl demonstrated superior antimicrobial activity, with over 6 log virus reduction in one min contact time. The coagulant formulation containing 1% EC and 10 kppm HOCl also demonstrated reasonable antiviral activity, with about 2 log reduction in 1 min of contact time. The coagulant formulation containing no EC but only HOCl displayed some antimicrobial activity but not as strong as the formulations containing the polymer EC.

### Example 3: Laboratory-Scale Preparation of Nitrile Materials Using a Dipping Process, and the Antiviral Nature of Different Coagulant and Nitrile Formulations Using the Process

In order to replicate the manufacturing conditions more accurately, a dipping process was designed, rather than producing the nitrile material in a petri dish.

For nitrile film fabrication, an aluminium can (a), a cylindrical-shaped glass (b), and a ceramic manikin hand (c) were used as formers as illustrated in FIG. 3.

The formers were dipped in a glass beaker containing 100 ml of a coagulant solution, followed by drying in an oven and then dipped in another glass beaker containing 100 ml of nitrile, followed by drying in an oven. Three different protocols were utilised that differed based on the durations of the dipping (i.e. dwell time) and temperature of drying were. Methods M, B and C were followed, as outlined below and in FIG. 4. Method C is the closest method to a commercial dipping protocol.

All materials were tested for anti-viral effect in the cell viability assay.

### Protocol M (FIG. 4a):

Each former was dipped in coagulant for 3 minutes at room temperature (25° C.), then dried at 60° C. for 5 minutes. The formers were then dipped in nitrile solution for 3-5 minutes at room temperature before being cured at 130° C. for 15 minutes.

The following formulations were added to a coagulant containing 14% calcium nitrate, 1.8% calcium stearate and about 0.5% wetting agent surfactants to prepare formulations using this protocol:
1. 50,000 ppm HOCl concentration in coagulant was achieved by dissolving five Sanitab™ tablets that were powdered with mortar and added gradually in 100 ml of coagulant solution.
2. 100,000 ppm HOCl concentration in coagulant was achieved by dissolving ten Sanitab™ tablets that were powdered with mortar and added gradually in 100 ml of coagulant solution.
3. 100,000 ppm HOCl concentration in coagulant was achieved by dissolving ten Sanitab™ tablets that were powdered with mortar and added gradually in 100 ml of coagulant solution. Then, 2 g Na-CMC polymer (Sigma Aldrich) was added to 100 ml of the coagulant containing 100,000 ppm HOCl.
4. 50,000 ppm HOCl concentration in coagulant was achieved by dissolving five Sanitab™ tablets that were powdered with mortar and added gradually in 100 ml of coagulant solution. Then, 2 g Na-CMC polymer was added to 100 ml of the coagulant containing 50,000 ppm HOCl.
5. 50,000 ppm HOCl concentration in coagulant was achieved by dissolving five Sanitab™ tablets that were powdered with mortar and added gradually in 100 ml of coagulant solution. Then, 1.65 g glycerol was added to 100 ml of the coagulant containing 50,000 ppm HOCl
6. 100,000 ppm HOCl concentration in coagulant was achieved by dissolving ten Sanitab™ tablets that were powdered with mortar and added gradually in 100 ml of coagulant solution. Separately, 9.9 gram of EC (Sigma Aldrich) was dissolved in 300 ml ethanol to give a 3.3% stock EC solution. In contrast to the other formulations, the coagulant contained 7% calcium nitrate, 0.45% calcium stearate+0.2% wetting agent surfactants. A new coagulant formulation was then prepared containing 2.5% EC and 25,000 ppm HOCl by mixing the 3.33% stock EC solution dissolved in ethanol and the coagulant containing 100,000 ppm HOCl at a ratio of (75%:25%) respectively. 75 ml of EC stock solution was added very slowly using an infusion pump at a rate of 2 ml/min to 25 ml of the coagulant containing 100,000 ppm HOCl whilst the coagulant solution was stirred at 1000 rpm. This process was found to be important as EC will agglomerate in the coagulant solution if added too rapidly.
7. Formulation 6 was mixed with formulation 4 at a ratio of 75%:25%, which implies that the final concentration of calcium nitrate in the coagulant solution was reduced by 75%. As mentioned earlier, the concentration of calcium nitrate determines the final thickness of the gloves. Therefore, in order to increase the concentration of calcium nitrate, 10.5 g of calcium nitrate was added to the final 100 ml solution. Also, to increase the concentration of calcium stearate in the final solution back to the original 1.8%, 1.35 g of calcium stearate was also added.
8. Control material commercial coagulant and nitrile solution set out previously.

As seen in FIG. 5, the most effective formulation was 50 kppm HOCl+2% Na-CMC.

### Protocol B (FIG. 4b):

Each former was dipped in coagulant for 1 minute at room temperature (25° C.), then dried at 90° C. for 1 minute. The formers were then dipped in nitrile solution for 2 minutes at room temperature before being cured at 90° C. for 6 minutes.

The following formulations were added to a coagulant containing 14% calcium nitrate, 1.8% calcium stearate and about 0.5% wetting agent surfactants to prepare formulations using this protocol:
1. A 40,000 ppm HOCl concentration in coagulant solution was prepared by dissolving four Sanitab™ tablets in 100 ml of coagulant.
2. A 60,000 ppm HOCl concentration in coagulant solution was prepared by dissolving six Sanitab™ tablets in 100 ml of coagulant.
3. 100,000 ppm HOCl concentration in coagulant solution was prepared by dissolving ten Sanitab™ tablets that were powdered with mortar and added gradually in 100 ml of coagulant solution. Then, 2 g Na-CMC polymer was added to 100 ml of the coagulant containing 100,000 ppm HOCl.
4. 100,000 ppm HOCL concentration in coagulant solution was prepared by dissolving ten Sanitab™ tablets that were powdered with mortar and added gradually in 100 ml of coagulant solution. Separately, a 3.33% ethyl cellulose (EC) solution was prepared in ethanol (3.33 g in 100 ml ethanol). A new coagulant formulation was prepared containing 2.5% EC and 25,000 ppm HOCl by mixing the 3.33% stock ethyl cellulose (EC) solution dissolved in the ethanol and the coagulant containing 100,000 ppm HOCl at a ratio of (75%:25%) respectively.
5. Control material using commercial coagulant and nitrile solution set out previously.

As seen in FIG. 6, the most effective formulation was that containing 25 kppm HOCl+2.5% EC, closely followed by the formulation containing 100 kppm HOCl+2% Na-CMC, both showing over 7 and 6 logs reduction in 1 min contact time.

### Protocol C (FIG. 4c):

Each former was initially dipped in coagulant for 2-3 minutes at 50-60° C. before being dried at 45° C. for a few seconds. The formers were then dipped in nitrile solution for a few seconds at 25-35° C. before being cured at 100-125° C. for 20 minutes.

The following formulations were added to a coagulant containing 14% calcium nitrate, 1.8% calcium stearate and about 0.5% wetting agent surfactants to prepare formulations using this protocol:
1. 50,000 ppm HOCl concentration in coagulant was achieved by dissolving five sodium dichloroisocyanurate (NaDCC) tablets that were powdered with mortar and added gradually in 100 ml of coagulant solution.
2. 100,000 ppm HOCl concentration in coagulant was achieved by dissolving ten Sanitab™ tablets that were powdered with mortar and added gradually in 100 ml of coagulant solution.
3. 100,000 ppm HOCl concentration in coagulant was achieved by dissolving ten Sanitab™ tablets that were powdered with mortar and added gradually in 100 ml of coagulant solution. Then, 2 g Na-CMC polymer was added to 100 ml of the coagulant containing 100,000 ppm HOCl.
4. Control material using commercial coagulant and nitrile solutions set out previously.

As seen in FIG. 7, the most effective formulations were the two containing HOCl only.

In total, it can be seen from the results that protocol B produced superior samples in terms of antiviral activity, followed by protocol M and finally protocol C.

An important observation that was made was that the concentration of calcium nitrate (Ca(NO₃)₂) has an important role in uniformity and thickness of the final material as previously suggested. This would have significant implication in the formulations utilising EC because there is a reduction in the concentration of calcium nitrate in the coagulant. For example, the uniformity of the sample made with the coagulant formulation 2.5% HOCl, 1.65% EC and 7% Ca(NO₃)₂ was negatively affected compared to the same formulation except with 14% Ca(NO₃)₂ concentration. All other samples having 14% Ca(NO₃)₂ formed nice uniform thick films.

Scanning electron microscope (SEM) images were obtained from some of the material samples prepared using the above protocols. FIG. 8a shows a control nitrile material formulated with commercially available coagulant and nitrile. The surface is smooth with the presence of small grooves. FIG. 8b shows a nitrile material prepared with a coagulant formulation including 50,000 ppm HOCl. As can be seen, the surface is smooth with a few creases. FIG. 8c shows a nitrile material prepared with a coagulant formulation including 5% HOCl, 1.5% Na-CMC, 14% CaNO₃. As can be seen, the surface is smooth with a few agglomerates of densely packed multifaceted particles. FIG. 8d shows a nitrile material prepared with a coagulant formulation including 5% HOCl, 1.65% EC, 14% CaNO₃. As can be seen, the surface is smooth with a few agglomerates of plate-like particles (around 3 μm in width and 10 μm in length). FIG. 8e shows a nitrile material prepared with a coagulant formulation including 5% HOCl, 1.65% glycerol, 14% CaNO₃. As can be seen, the surface is smooth with a few agglomerates of needle-like particles.

Physical property measurements, such as tensile strength measurements, were also performed on the materials are the results are summarised in FIG. 9. It can be seen that all of the nitrile material formulations, other than the one with 7% calcium nitrate concentration, had a better tensile strength performance compared to the control glove. This result was anticipated as adding extra polymers to the coagulant formulation should enhance the mechanical stability and properties of the gloves.

### Example 4. Antibacterial Activity of Nitrile Materials Made with Varying Coagulant Formulations

Antibacterial testing was performed on selected materials as described below. Five contact time-points were tested: 0 min (TO), 1 min (T1), 2 mins (T2) and 5 mins (T5). Antibacterial studies were performed against Staphylococcus aureus according to ASTM D7907.

### Methods

Bacteria Staphylococcus aureus NCTC 10788 were re-streaked on Horse blood agar plates Oxoid (Fisher scientific-PB0114A) and incubated for 24 hours at 37° C. prior to testing.

### Reagents

For anti-bacteria testing, cell suspensions were made with Phosphate Buffer saline (PBS). Neutralisation buffer (NB) contained Mueller Hinton Broth-Oxoid (21 g/L) (Fisher scientific-CM0405B) with 0.7% Arabic gum. Bacterial suspensions were spread on Mueller Hinton Agar (38 g/L).

With a sterile loop, 5-10 colonies were mixed into 5 ml of sterile PBS. Suspension optical density was measured at 625 nm and adjusted to 0.5 McFarland standard (OD625 should read 0.08-0.13). The suspension was diluted 1 in 2 with Mueller Hinton Broth (MHB), to give a 20 μL inoculum containing 10⁶ CFU. A 1 in 2 dilution with neutralisation buffer (NB) was also made for control measures. In replicate (n=3), 1 mL of a 1/1000 dilution of both the MHB and NB bacteria suspension were plated on Mueller Hinton agar (MHA) to confirm initial CFU/mL, along with a neat sample with penicillin as a control measure. A 20 μl sample of the MHB bacterial suspension was placed on a control and test sample and a glass coverslip placed on top with sterile tweezers. Samples were left for 0, 1, 2 or 5 minutes (time periods could be modified up to 30 minutes) and then transferred into 10 ml of neutralisation buffer and inverted 15 times to neutralise the formula and re-suspend any viable bacteria cells. 1 mL of a neat and 1/10 dilution of each sample was spread on agar plates with replicates (n=3) and incubated at 37° C. for 24 hours. Colonies were counted manually, and the average Log10 of the CFU/mL was calculated. The log reduction was calculated by subtracting the Log number of colonies obtained from the test sample from the control sample.

Experiment 1=the following formulations were prepared using the Protocol M method:
1) Control coagulant (14% calcium nitrate, 1.8% calcium stearate and about 0.5% wetting agent surfactants)+nitrile;
2) 5% HOCl+1.65% glycerol+14% calcium nitrate, 1.8% calcium stearate and about 0.5% wetting agent surfactants;
3) 10% HOCl+14% calcium nitrate, 1.8% calcium stearate and about 0.5% wetting agent surfactants;
4) 2.5% HOCl+1.65% EC+7% calcium nitrate, 0.45% calcium stearate, 0.2% wetting agent surfactants;
5) 2.5% HOCl+1.65% EC+14% calcium nitrate, 1.8% calcium stearate and about 0.5% wetting agent surfactants;
6) 5% HOCl+14% calcium nitrate, 1.8% calcium stearate and about 0.5% wetting agent surfactants;
7) 5% HOCl+1.65% NA-CMC+14% calcium nitrate, 1.8% calcium stearate and about 0.5% wetting agent surfactants.

Experiment 2=the following formulations were prepared using the Protocol M method:
Control coagulant (14% calcium nitrate, 1.8% calcium stearate and about 0.5% wetting agent surfactants)+nitrile;
1) 5% HOCl+14% calcium nitrate, 1.8% calcium stearate and about 0.5% wetting agent surfactants;
2) 10% HOCl+14% calcium nitrate, 1.8% calcium stearate and about 0.5% wetting agent surfactants;
3) 10% HOCl+2% NA-CMC+14% calcium nitrate, 1.8% calcium stearate and about 0.5% wetting agent surfactants;
4) 2.5% HOCl+2.5% EC+14% calcium nitrate, 1.8% calcium stearate and about 0.5% wetting agent surfactants.

Experiment 3=the following formulations were prepared using the Protocol B method:
Control coagulant (14% calcium nitrate, 1.8% calcium stearate and about 0.5% wetting agent surfactants)+nitrile;
1) 5% HOCl+14% calcium nitrate, 1.8% calcium stearate and about 0.5% wetting agent surfactants;
2) 10% HOCl+14% calcium nitrate, 1.8% calcium stearate and about 0.5% wetting agent surfactants;
3) 10% HOCl+2% NA-CMC+14% calcium nitrate, 1.8% calcium stearate and about 0.5% wetting agent surfactants;
4) 2.5% HOCl+2.5% EC+14% calcium nitrate, 1.8% calcium stearate and about 0.5% wetting agent surfactants.

Experiment 4=the following formulations were prepared using the Protocol C method:
Control coagulant (14% calcium nitrate, 1.8% calcium stearate and about 0.5% wetting agent surfactants)+nitrile;
1) 5% HOCl+14% calcium nitrate, 1.8% calcium stearate and about 0.5% wetting agent surfactants;
2) 10% HOCl+14% calcium nitrate, 1.8% calcium stearate and about 0.5% wetting agent surfactants;
3) 10% HOCl+2% NA-CMC+14% calcium nitrate, 1.8% calcium stearate and about 0.5% wetting agent surfactants;
4) 2.5% HOCl+2.5% EC+14% calcium nitrate, 1.8% calcium stearate and about 0.5% wetting agent surfactants.

### Results

As seen in FIG. 10, the most effective time period for formulations prepared by Protocol M was 5 minutes. The coagulant formulation including 5% HOCl+1.65% glycerol was the most effective with the other formulations being similarly effective.

As seen in FIG. 11, different formulations prepared by Protocol M were not as effective as those tested in the previous experiment. The most effective formulation was 100 kppm HOCl+2% Na-CMC.

As seen in FIG. 12, the formulations prepared by Protocol B were the most effective at a contact time of 5 minutes, with a coagulant formulation including 10% HOCl+2% Na-CMC being the most effective, as in the previous experiment.

As seen in FIG. 13, formulations prepared by Protocol C were not as effective as those tested in the first experiment. The most effective formulation included 10% HOCl.

### Example 5. Comparison of Antimicrobial Effects of Nitrile Material Including Coagulant Formulations Described and Commercially Available Antimicrobial Glove Materials

The antiviral properties of a Biocote® glove was compared with a nitrile material prepared with a coagulant formulation including 10,000 ppm HOCl, 1% EC and 0.1% glycerol, and a commercially available control with no known antimicrobial/antiviral properties. A coating formulation of 0.5 ml 1% ethyl cellulose+0.1% Glycerol solution were sprayed per 10 cm² of a nitrile glove, to give a coverage of 50 μl/cm². 200 μl of 1% HOCl solution was then over-sprayed per 10 cm² to give a coverage of 20 μl/cm². Antiviral contact time was 1 minute.

As illustrated in FIG. 14, the test sample had an antiviral effect that matched that of the positive control (cDMEM), while the Bicote and control samples showed negligible antiviral effect.

In summary, formulations have been prepared that can be incorporated into the coagulant solution and used to prepare nitrile material having antimicrobial and antiviral properties.

1. A coagulant formulation for use in the manufacture of a material formed by dipping, the coagulant formulation comprising a coagulant, one or more wetting agent surfactant and solvent, wherein the formulation further comprises one or more non-biological antimicrobial and/or antiviral agent.

2. The formulation of claim 1, wherein the formed material is latex, nitrile, vinyl and/or nitrile/vinyl.

3. The formulation of claim 1 or claim 2, wherein the one or more non-biological antimicrobial and/or antiviral agent is selected from: a disinfectant, a cleaning and/or sanitising, agent a bleach, an alcohol, an oxidant, a weak acid, or a bactericidal agent and combinations thereof.

4. The formulation of any one of claims 1 to 3, wherein the one or more non-biological antimicrobial and/or antiviral agent is electrolysed water, hypochlorous acid sodium dichloroisocyanurate (NaDCC),, a metal oxide, a poloxamer, a quaternary ammonium salt, fluoride ions, chitosan, poly(hexamethylene guanidine) (PHMG), carnosol, alpha-tocopherol, glutaraldehyde, hyaluronic acid, citric acid, acetic acid, an alcohol, chlorhexidine digluconate, powdered alcohol, and combinations thereof.

5. The formulation of any one of claims 1 to 4, wherein the one or more non-biological antimicrobial and/or antiviral agent is selected from: hypochlorous acid (HOCl), electrolysed water or precursors thereof.

6. The formulation of any one of claims 1 to 5, wherein the one or more non-biological antimicrobial and/or antiviral agent is present in the formulation in an amount of between about 0.1% and about 20%.

7. The formulation of any one of claims 1 to 6, wherein the one or more non-biological antimicrobial and/or antiviral agent is HOCl and is present in an amount of between about 0.1% and about 10%.

8. The formulation of any one of claims 1 to 7, wherein the formulation further includes one or more encapsulation agent.

9. The formulation of claim 8, wherein the one or more encapsulation agent is selected from: ethyl cellulose (EC), methyl cellulose (MC), carboxy methyl cellulose (CMC), and combinations thereof Poly(ethylene glycol) (PEG), polyethylene oxide (PEO), Polyvinyl pyrrolidone (PVP), Polyvinyl alcohol (PVA), Polyacrylic acid (PAA), Polyacrylamides, N-(2-Hydroxypropyl) methacrylamide (HPMA), poly Divinyl Ether-Maleic Anhydride, Polyoxazolines, Polyphosphates, Polyphosphazenes, Xanthan Gum, Pectin, Chitosan, Dextran, Carrageenan, Guar Gum, Hydroxypropylmethyl cellulose (HPMC), Hydroxypropyl cellulose (HPC), Hydroxyethyl cellulose (HEC), Sodium carboxy methyl cellulose (Na-CMC), Hyaluronic acid (HA), Albumin, Starch, gum arabic, dextrin glue, glycerol, and combinations thereof.

10. The formulation of claim 8 or claim 9, wherein the one or more encapsulation agent is selected from: cellulose including ethyl cellulose, methyl cellulose, cellulose acetate and cellulose acetate butyrate, poly(methyl methacrylate) (PMMA), poly(2-phenyl-2-oxazoline) (PPhOx), polyethylene oxide (PEO), poly(2-hydroxyethyl methacrylate), poly(1,2butylene glycol) (PBG), polyacrylonitrile, polyvinyle chloride, polyvinylidene fluoride, and combinations thereof.

11. The formulation of any one of claims 8 to 10, wherein the one or more encapsulation agent is carboxy methyl cellulose and/or methyl cellulose, both or either of which are present in an amount of between about 0.1% and about 5%.

12. The formulation of any one of claims 8 to 11, wherein the one or more encapsulation agent is ethyl cellulose and is present in an amount of between about 0.1% and about 5%.

13. The formulation of any one of claims 1 to 12, wherein the formulation further includes a plasticiser or the one or more non-biological antimicrobial and/or antiviral agent is selected also to have properties of a plasticiser.

14. The formulation of claim 13, wherein the plasticiser is selected from: glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, soybean oil, dodecanol, lauric acid, tributyrin, trilaurin, epoxidised soybean oil, mannitol, diethanolamine, fatty acids, triethyl citrate, and/or sucrose esters, and combinations thereof.

15. The formulation of claim 13 or claim 14, wherein the plasticiser is glycerol and is present in the formulation in an amount of between about 0.1% and about 5%.

16. The formulation of any one of claims 1 to 15, wherein the formulation further includes an anti-tack agent.

17. The formulation of claim 16, wherein the anti-tack agent is selected from calcium stearate, zinc stearate and/or magnesium stearate.

18. The formulation of claim 16 or claim 17, wherein the anti-tack agent is present in an amount of between about 0.1% and about 5%, optionally about 1.8%.

19. The formulation of any one of claims 1 to 18, wherein the coagulant is selected from calcium nitrate, calcium chloride and ammonium nitrate.

20. The formulation of any one of claims 1 to 19, wherein coagulant is present in an amount of between about 2% and about 20%, optionally about 14%.

21. The formulation of any one of claims 1 to 20, wherein the solvent is selected from water, alcohol, acetone, and combinations thereof.

22. The formulation of any one of claims 1 to 21, wherein the formulation further includes a neutral, pleasant, or unpleasant fragrance and/or flavouring, and/or colourant.

23. A method for producing a formable material, the method comprising the steps of:
a) Dipping a former in a coagulant formulation,
b) Drying the dipped former,
c) Dipping the dried former in a solution comprising latex, nitrile, polyvinyl chloride and/or a mixture of nitrile/PVC, and
d) Curing the former,
wherein the coagulant formulation is a coagulant formulation as claimed in any one of claims 1 to 22.

24. The method as claimed in claim 23, wherein the former is dipped in coagulant formulation for between about 1 second and up to about 3 minutes.

25. The method as claimed in claim 23 or claim 24, wherein the former is dipped in coagulant formulation at a temperature of between about 18° C. and about 50° C., preferably at about 25° C.

26. The method as claimed in any one of claims 23 to 25, wherein the coagulant-dipped former from step a) is dried for between about 1 second and about 5 minutes.

27. The method as claimed in any one of claims 23 to 26, wherein the coagulant-dipped former from step a) is dried at a temperature of between about 60° C. and about 90° C.

28. The method as claimed in any one of claims 23 to 27, wherein the dried coagulant-dipped former from step b) is dipped for between about 1 second to about 5 minutes.

29. The method as claimed in any one of claims 23 to 28, wherein the dried coagulant-dipped former from step b) is dipped in the solution at a temperature of between about 18° C. to about 35° C., preferably at about 25° C.

30. The method as claimed in any one of claims 23 to 29, wherein coated former from step c) is cured for between about 6 mins to about 20 minutes, preferably 15 minutes.

31. The method as claimed in any one of claims 23 to 30, wherein coated former from step c) is cured at a temperature of between about 90° C. and about 130° C.

32. The method as claimed in any one of claims 23 to 31, wherein the method further includes a pre-step in which the former is heated before being dipped in coagulant formulation.

33. The method as claimed in claim 32, wherein the former is heated for about 2-3 minutes.

34. The method as claimed in claim 32 or claim 33, wherein the former is heated at a temperature of between about 50° C. and about 60° C.

35. The method as claimed in any one of claims 23 to 34, wherein the formable material and former are for the manufacture of a glove, optionally a disposable glove.
